(19) United States
(12) Patent Application Publication
(10) Pub. No.: US 2009/0108790 A1
(43) Pub. Date: Apr. 30, 2009

(54) Control structure of an electric fan

(76) Inventor: Wen-Hui Chen, Yongkang City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/979,082

(22) Filed: Oct. 31, 2007

(51) Int. Cl. H02P 29/00

(52) U.S. Cl. 318/514

(57) ABSTRACT

An electric fan includes a motor driving circuit, a controller, and a stepless speed-change device; the motor driving circuit is electrically connected to a blades-driving motor of an electric fan as well as a power circuit; the controller is electrically connected to the motor driving circuit while the stepless speed-change device is electrically connected to the controller therefore the rotational speed of the blades-driving motor of the electric fan can be adjusted in a stepless manner.

### BACKGROUND OF THE INVENTION

1. Field of the Invention

The present invention relates to a control structure of an electric fan, more particularly one, which allows the speed of the electric fan to be adjusted in a stepless manner, thus providing more convenience for the users.

2. Brief Description of the Prior Art

Motors are used as the power source for electric fans, and are usually controlled by means of either a switch or a knob, which can be moved to change the input impedance so as to change the amount of electric current supplied to the blades-driving motor; thus, the rotational speed of the blades-driving motor is changed.

However, there are only a limited number of choices available to the users in changing the rotational speed of the blades-driving motors of such electric fans. In other words, people aren't allowed to adjust the speed of the electric fans to any value between the highest speed and the lowest one according to their needs.

Therefore, such a control structure of electric fans isn't convenient to use. And, it is a main object of the present invention to provide an improvement on a control structure of an electric fan to overcome the above problem.

### SUMMARY OF THE INVENTION

An electric fan according to an embodiment of the present invention includes a controller, a stepless speed-change device, and a motor driving circuit, which is electrically connected to a blades-driving motor of an electric fan as well as a power circuit. The controller is connected to the motor driving circuit while the stepless speed-change device is connected to the controller; the controller will change the amount of electric current supplied from the motor driving circuit to the blades-driving motor when the stepless speed-change device is operated. Consequently, the speed of the electric fan can be adjusted to any value between the highest and the lowest ones.

### BRIEF DESCRIPTION OF THE DRAWINGS

The present invention will be better understood by referring to the accompanying drawings, wherein:

FIG. 1 is a circuit block diagram of the present invention,

FIG. 2 is a circuit diagram of the present invention, and

FIG. 3 is a view of an electric fan according to the invention.

### DETAILED DESCRIPTION OF THE PREFERRED EMBODIMENTS

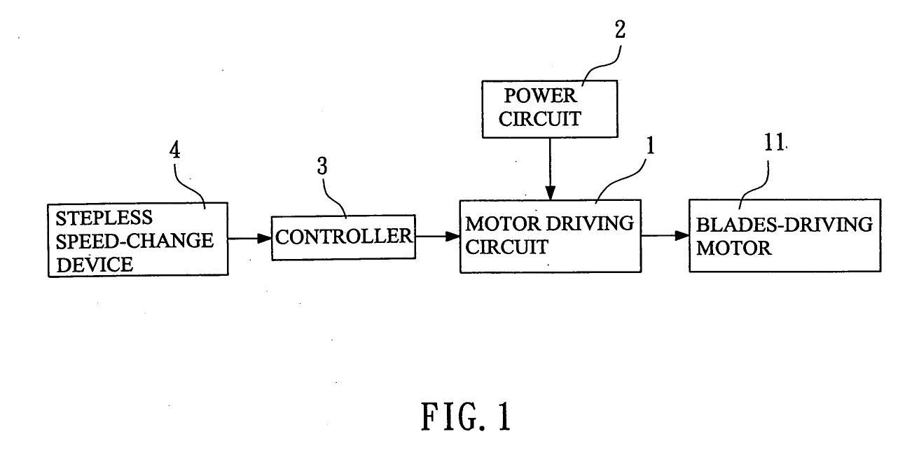

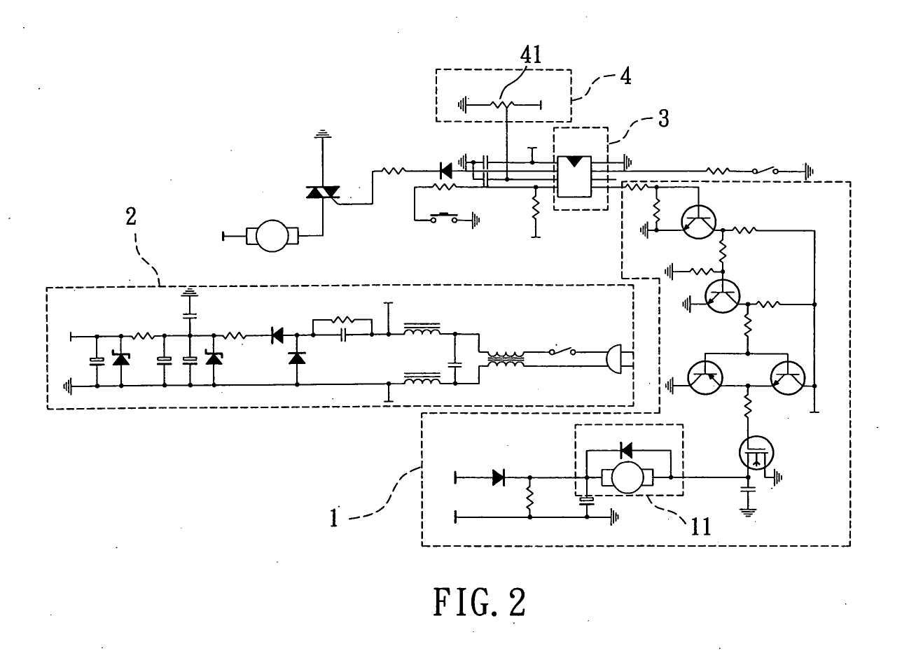

Referring to FIGS. 1 and 2, which are a circuit block diagram, and a circuit diagram respectively, a preferred embodiment of an electric fan of the present invention includes a motor driving circuit 1, a blades-driving motor 11 electrically connected to the motor driving circuit 1, a power circuit 2, a controller 3, and a stepless speed-change device 4. The motor driving circuit 1 is electrically connected to the power circuit 2. The motor driving circuit 1 is electrically connected to the controller 3. And, the controller 3 is electrically connected to the stepless speed-change device 4, which comprises adjustable resistors 41.

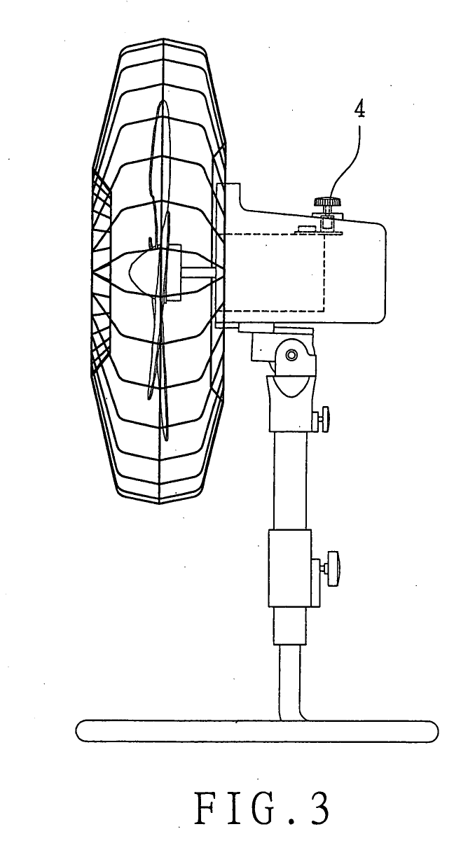

Therefore, referring to FIG. 3, a person is allowed to adjust the rotational speed of the blades-driving motor 11 of the electric fan in a stepless manner by means of operating the stepless speed-change device 4, thus changing the speed of wind produced from the electric fan; the controller 3 will change the amount of electric current supplied from the motor driving circuit 1 to the blades-driving motor 11 when the stepless speed-change device 4 is moved.

From the above description, it can be seen that the control structure of the present invention has an advantage over the currently existing one: there are only a limited number of choices available to the user in changing the speed of an electric fan with the currently existing control structure, yet with the control structure of the present invention, the rotational speed of the blades-driving motor can be adjusted in a stepless manner; in other words, the speed of the electric fan of the present invention can be adjusted to any value between the highest speed and the lowest one.

What is claimed is:

1. A control structure of an electric fan, comprising
a motor driving circuit, which is electrically connected to a blades-driving motor of an electric fan, and which is electrically connected to a power circuit;
a controller electrically connected to the motor driving circuit; and
a stepless speed-change device electrically connected to the controller.

2. The control structure of an electric fan as claimed in claim 1, wherein stepless speed-change device comprises a plurality of adjustable resistors.
